(19) United States
(12) Patent Application Publication
(10) Pub. No.: US 2007/0174159 A1
(43) Pub. Date: Jul. 26, 2007

(54) Methods, systems, and products for monitoring transactions

(76) Inventor: Douglas O'Neil, Marietta, GA (US)

Correspondence Address: SCOTT P. ZIMMERMAN, PLLC, PO BOX 3822, CARY, NC, 27519, US

(21) Appl. No.: 11/323,691

(22) Filed: Dec. 30, 2005

(51) Int. Cl. G07F 19/00

(52) U.S. Cl. 705/34

(57) ABSTRACT

Methods, systems, and products are disclosed for monitoring transactions. Retail transaction messages are received, and the retail transaction messages describe retail transactions between retail subscribers and a software application. Wholesale transaction messages are also received, and the wholesale transaction messages describe wholesale transactions between the software application and wholesale subscribers of a reseller of communications services. The retail transaction messages and the wholesale transaction messages are stored in a transactions database.

### NOTICE OF COPYRIGHT PROTECTION

A portion of this disclosure and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to communications and to computers and, more particularly, to monitoring transactions between software applications.

Network operators are increasingly forming content and software partnerships. As a network operator offers more features and services to their subscribers, the network operator may utilize software applications developed by third party vendors. The network operator, for example, may offer its subscribers access to an address book or to a listing of contacts. The software application that provides the address book, or the list of contacts, may be developed by a third party software developer. The network operator thus partners with the third party software developer to provide enhanced features and services to subscribers.

The network operator also wants to correctly account for the use of these partnership applications. Whenever a subscriber utilizes a third party's software application, the third party partner usually wants compensation for that use. Whenever a subscriber, for example, accesses their personalized address book, or their personalized list of contacts, the software partner wants a royalty or payment for that usage. The network operator must then correctly account for any usage of a software application to ensure the partnering developer is correctly compensated. What is needed, then, are methods, systems, and products that monitor transactions with software applications.

### SUMMARY

The aforementioned problems, and other problems, are reduced, according to the exemplary embodiments, using methods, systems, and products that monitor transactions with software applications. Whenever a network operator develops a service delivery partnership with a software developer, exemplary embodiments monitor all transactions with the developer's software application. Any transaction with the partner's software application is recorded in a database. If a retail subscriber of the network operator transacts with the partner's software application, that transaction is recorded in the database. Even if the partner's software application is accessed by a wholesale subscriber of a wholesale reseller, that transaction is recorded in the database. Exemplary embodiments thus track any and all usage of a software application, whether used by retail customers or by wholesale customers. Any transaction with a software application is thus tracked by a system-wide transaction database. The network operator may then retrieve any information regarding those transactions and appropriately bill the retail or wholesale subscriber. The network operator may then correctly compensate the partner for usage of the partner's software application.

The exemplary embodiments describe a method for monitoring transactions in a communications network. Retail transaction messages are received, and the retail transaction messages describe retail transactions between retail subscribers and a software application. Wholesale transaction messages are also received, and the wholesale transaction messages describe wholesale transactions between the software application and wholesale subscribers of a reseller of communications services. The retail transaction messages and the wholesale transaction messages are stored in a transactions database.

In another of the embodiments, a system is disclosed for monitoring transactions. A transactions database is stored in memory, and a processor communicates with the memory. The processor receives retail transaction messages describing retail transactions between retail subscribers and a software application. The processor also receives wholesale transaction messages describing wholesale transactions between the software application and wholesale subscribers of a reseller of communications services. The processor stores the retail transaction messages and the wholesale transaction messages in the transactions database.

In yet another embodiment, a computer program product is also disclosed for monitoring transactions. The computer program product comprises a computer-readable medium storing computer-readable instructions. These instructions receive retail transaction messages and wholesale transaction messages. The retail transaction messages describe retail transactions between retail subscribers and a software application. The wholesale transaction messages describe wholesale transactions between the software application and wholesale subscribers of a reseller of communications services. The retail transaction messages and the wholesale transaction messages are stored in a transactions database.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating a system for monitoring transactions, according to exemplary embodiments;

FIGS. 2 and 3 are more detailed schematics illustrating the system for monitoring transactions, according to more exemplary embodiments;

FIGS. 4 and 5 are schematics illustrating another configuration for monitoring transactions, according to yet more exemplary embodiments;

FIGS. 6 and 7 are still more detailed schematics illustrating the system for monitoring transactions, according to still more exemplary embodiments;

FIGS. 8 and 9 are schematics illustrating supplementary applications, according to exemplary embodiments;

FIG. 10 is a schematic illustrating billing queries, according to more exemplary embodiments;

FIG. 11 depicts another possible operating environment for exemplary embodiments;

FIG. 12 is a schematic illustrating alternative operating environments;

FIG. 13 is a schematic further illustrating various communications devices for provisioning communications services, according to the exemplary embodiments; and

FIG. 14 is a block diagram further illustrating the communications device, according to yet more of the exemplary embodiments

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

Exemplary embodiments record transactions involving retail, wholesale, and content partnerships. As those of ordinary skill in the art understand, many communications network operators are forming partnerships with third parties. These partnerships allow the network operator to provide enhanced retail applications, wholesale applications, and content offerings to subscribers. Network operators, for example, are partnering with software developers to offer access to email applications, voicemail applications, calendaring applications, address books, contact lists, and other software application services. Network operators are also partnering with wholesalers, who then resell access and applications to their own subscriber base. Network operators are also partnering with content providers to offer a larger selection of content to subscribers. The network operator, then, may partner with many different entities to satisfy the communications needs of subscribers.

The exemplary embodiments monitor the use of these applications. Because the network operator partners to provide access to retail and wholesale software services/applications, the network operator must correctly monitor and account for a subscriber's individual usage of these partnership services. When a subscriber utilizes an application, whether offered by the network operator or a reseller, the network operator, the exemplary embodiments track or record the usage details of that application. The exemplary embodiments thus allow the network operator to correctly account for and correctly bill for that usage.

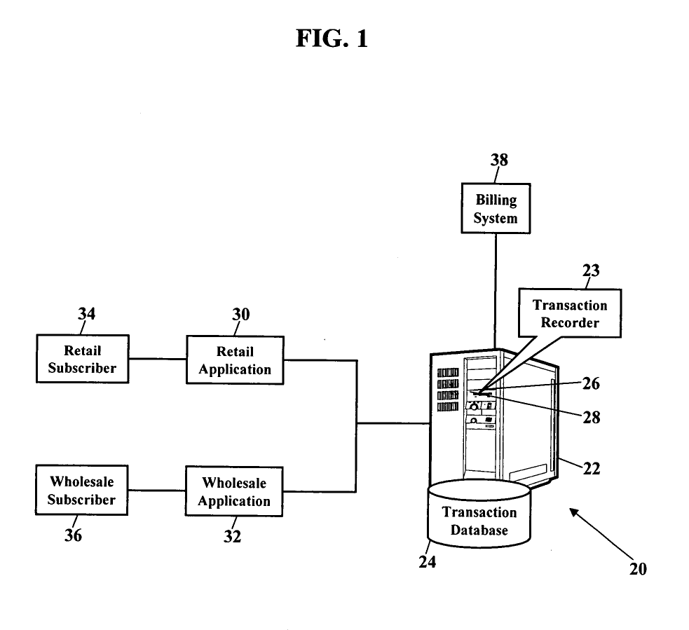

FIG. 1 provides an illustration. FIG. 1 is a simplified schematic illustrating a system for monitoring transactions, according to exemplary embodiments. The system 20 is illustrated as a computer 22, yet the system 20 may be any processor-controlled device. The system 20 includes a transaction recorder 23 and a transaction database 24 stored in memory 26 of the computer 22. A processor 28 communicates with the memory 26. The transaction recorder 23 is a software application that instructs the processor 28 to record any and all transactions involving a retail application 30 and/or a wholesale application 32. The retail application 30 is any software application utilized by a subscriber 34 of a retail service provider (such as a network operator-carrier). The wholesale application 32 is any application utilized by a subscriber 36 of a reseller of communications services. Whenever the retail application 30 or the wholesale application 32 is invoked or called, the transaction recorder 23 instructs the processor 28 to record that transaction in the transaction database 24. The processor 28 thus accounts for each subscriber's usage of the retail application 30 and/or the wholesale application 32 A billing system 38 may then obtain those transaction records from the transaction database 24, thus allowing each individual subscriber 34 and 36 to be correctly billed for the usage.

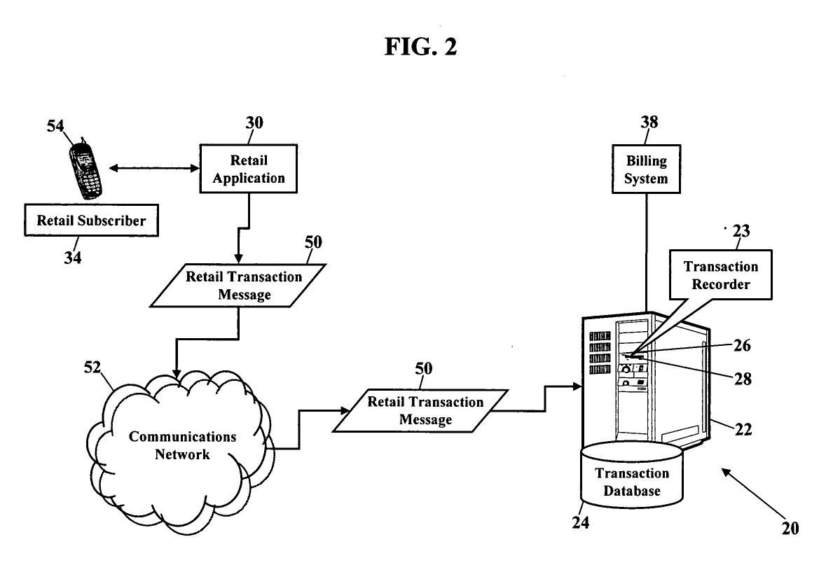

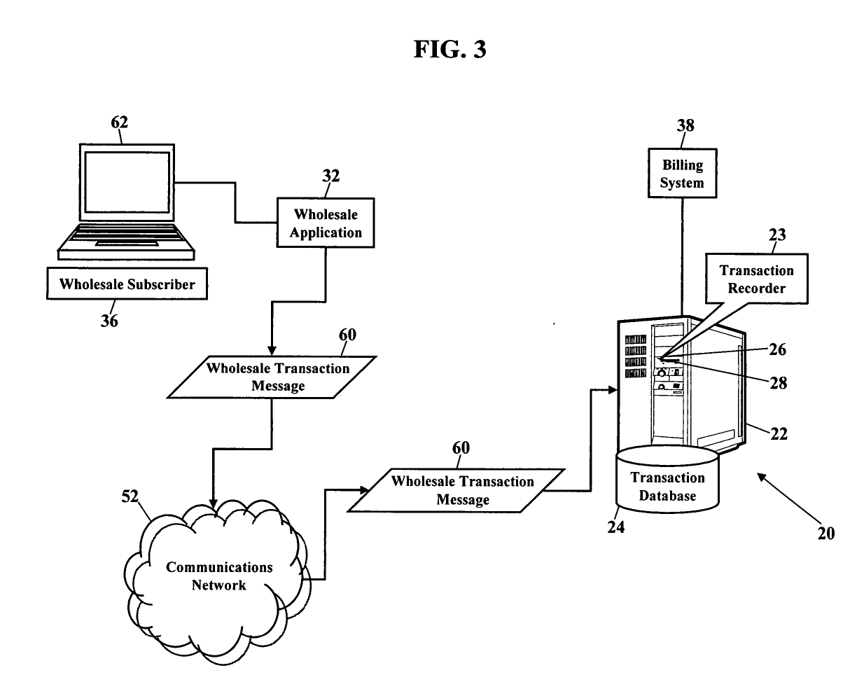

FIGS. 2 and 3 are more detailed schematics illustrating the system 20 for monitoring transactions, according to more exemplary embodiments. FIG. 2 illustrates a retail transaction message 50. The system 20 receives the retail transaction message 50 via a communications network 52. The retail transaction message 50 describes the details of a transaction between the retail subscriber 34 and the retail application 30. The retail application 30 may be any software application that provides a service, feature, enhancement, or content to the subscriber 34. The retail application 30, for example, may involve email, messaging, voicemail, ring tones, calendars, or any other software application. Any time the subscriber's communications device 54 calls, invokes, or transacts with the retail application 30, the retail transaction message 50 is sent. FIG. 2 illustrates the retail transaction message 50 originating from the retail application 30. That is, any time the subscriber's communications device 54 contacts the retail application 30, the retail application 30 may log that contact. The retail application 30 may then send the retail transaction message 50 to the transaction recorder 23 operating in the computer 22. The retail transaction message 50 contains the details of one or more transactions or contacts between the subscriber's communications device 54 and the retail application 30. The retail transaction message 50 communicates via the communications network 52 to the computer 22, where the processor 28 stores the retail transaction message 50 in the transactions database 24. The billing system 38 may then access the transactions database 24 and account for the subscriber's use of the retail application 30.

FIG. 3 illustrates a wholesale transaction message 60. The wholesale transaction message 60 describes the details of a transaction between the wholesale subscriber 36 and the wholesale application 32. The wholesale application 32 may be any software application that provides a service, feature, enhancement, or content to the wholesale subscriber 36. The wholesale application 32 may again involve (to name only a few) email, messaging, voicemail, calendar, Voice over Internet Protocol calling, or any other software application. Any time the wholesale subscriber's communications device 62 contacts, calls, invokes, or transacts with the wholesale application 32, the wholesale application 32 may log that contact. The wholesale application 32 may then send the wholesale transaction message 60 to the computer 22, where the processor 28 adds the wholesale transaction to the transactions database 24. The billing system 38 may then access the transactions database 24 and account for the subscriber's use of the wholesale application 32.

The exemplary embodiments may be applied regardless of networking environment. The communications network 52 may be a cable network operating in the radio-frequency domain and/or the Internet Protocol (IP) domain. The communications network 52, however, may also include a distributed computing network, such as the Internet (sometimes alternatively known as the “World Wide Web”), an intranet, a local-area network (LAN), and/or a wide-area network (WAN). The communications network 52 may include coaxial cables, copper wires, fiber optic lines, and/or hybrid-coaxial lines. The communications network 52 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network, regardless of physical componentry, physical configuration, or communications standard(s).

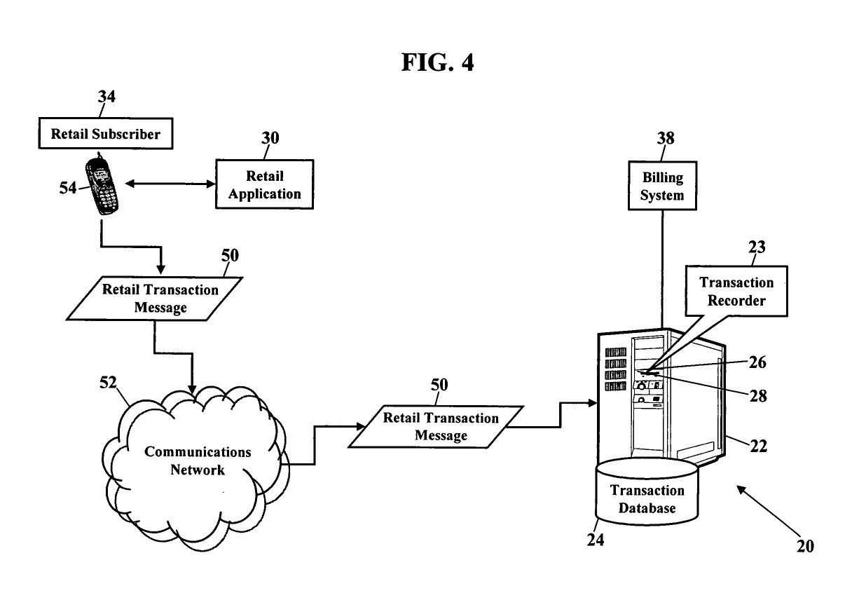

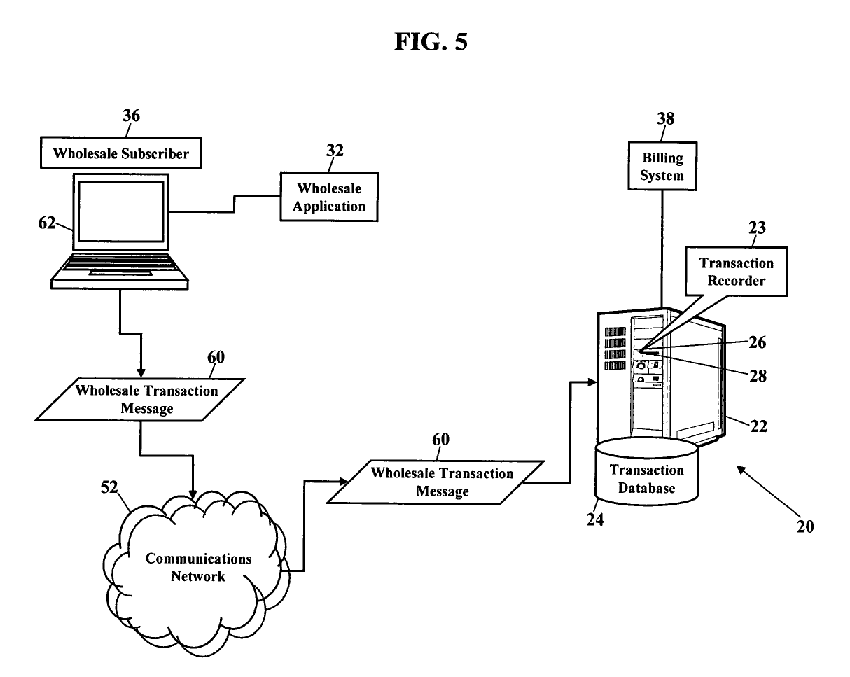

FIGS. 4 and 5 are schematics illustrating another configuration for monitoring transactions, according to yet more exemplary embodiments. FIG. 4 illustrates the retail subscriber's communications device 54 generating the retail transaction message 50, while FIG. 5 illustrates the wholesale subscriber's communications device 62 sending the wholesale transaction message 60 to the computer 22. Here, then, each time the subscriber transacts with an application, the subscriber's communications device (54 or 62) notifies the transaction database 24. So, whether the application or the subscriber's device notifies the transaction database 24, the transaction database 24 fully documents that application usage. The subscriber's use of any application, whether retail or wholesale, may thus be correctly recorded and billed.

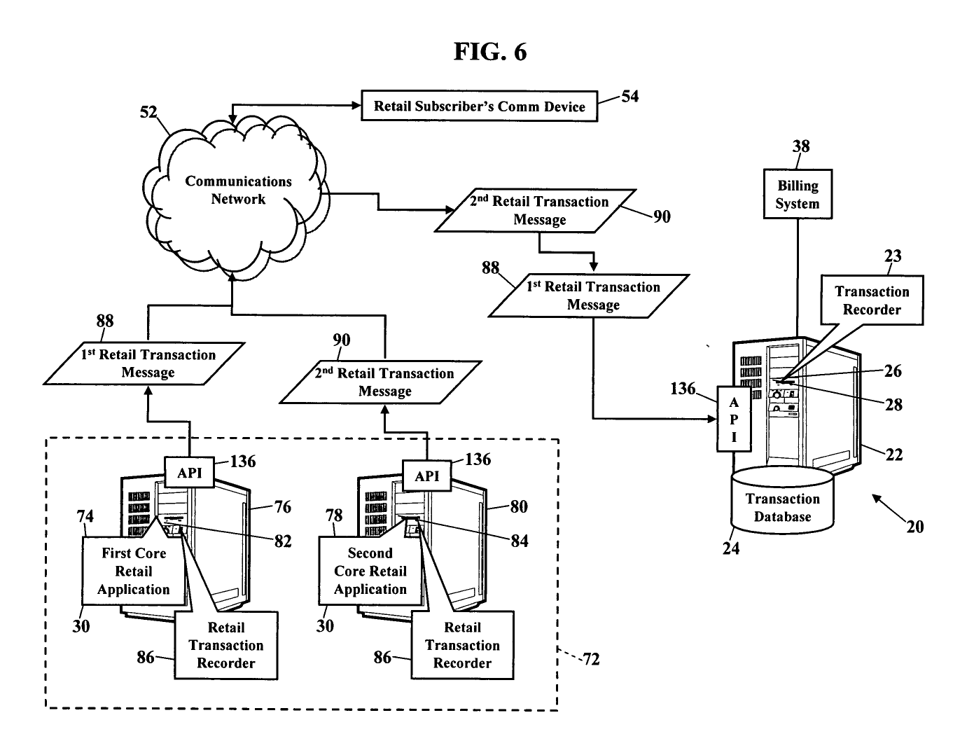

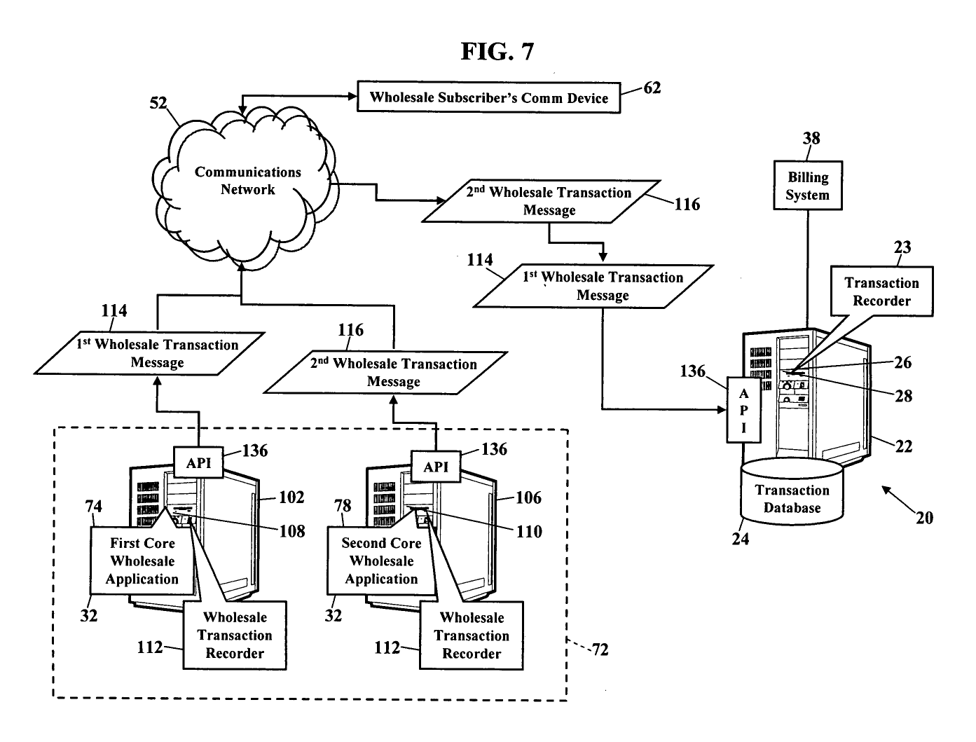

FIGS. 6 and 7 are still more detailed schematics illustrating the system 20 for monitoring transactions, according to still more exemplary embodiments. FIG. 6 illustrates multiple retail applications 30 communicating with, or operating within, a network operator's communications network 72. These multiple retail applications 30 are illustrated as a first core retail application 74 operating within a first core server 76 and a second core retail application 78 operating within a second core server 80. While only two retail applications 74 and 78 are shown, the network operator's communications network 72 may include more or less retail applications. The first core retail application 74 is stored within memory 82 of the first core server 76, while the second core retail application 78 is stored within memory 84 of the second core server 80. A retail transaction recorder 86 is also stored within the memory 82 and 84 of each core server 76 and 80. The retail transaction recorder 86 is a software application that observes, records, and/or logs each transaction with the retail subscriber's communications device 54. For example, any time the subscriber's communications device 54 calls, invokes, or transacts with the first core retail application 74, the retail transaction recorder 86 (operating within the first core server 76) sends a first retail transaction message 88. Likewise, any time the subscriber's communications device 54 transacts with the second core retail application 78, the retail transaction recorder 86 (operating within the second core server 80) sends a second retail transaction message 90. The first 88 and the second 90 retail transaction messages contain the details of each respective transaction. The first 88 and the second 90 retail transaction messages communicate via the communications network 52 to the computer 22, where the processor 28 adds the details of each transaction to the network-wide transactions database 24. The billing system 38 may then access the transactions database 24 and account for the subscriber's use of the first core retail application 74 and the second core retail application 78.

FIG. 7 illustrates multiple wholesale applications 32. Here the multiple wholesale applications 32 also communicate with, or operating within, the network operator's communications network 72. These multiple wholesale applications 32 are illustrated as a first core wholesale application 100 operating within a first core wholesale server 102 and a second core wholesale application 104 operating within a second core wholesale server 106. While only two wholesale applications 100 and 104 are shown, those of ordinary skill in the art recognize the network operator may utilize include more or less wholesale applications. The first core wholesale application 100 is stored within memory 108 of the first core wholesale server 102, while the second core wholesale application 104 is stored within memory 110 of the second core wholesale server 106. Here again a wholesale transaction recorder 112 observes, records, and/or logs each transaction with the wholesale subscriber's communications device 62. The wholesale transaction recorder 112 (operating within the first core wholesale server 102) sends a first wholesale transaction message 114, and the wholesale transaction recorder 112 (operating within the second core wholesale server 106) sends a second wholesale transaction message 116. The first 114 and the second 116 wholesale transaction messages contain the details of each respective wholesale transaction. The first 114 and the second 116 wholesale transaction messages communicate via the communications network 52 to the computer 22, where the processor 28 stores the details of each transaction in the transactions database 24. The billing system 38 may then access the transactions database 24 and account for the subscriber's use of the first 100 and the second 104 core wholesale applications.

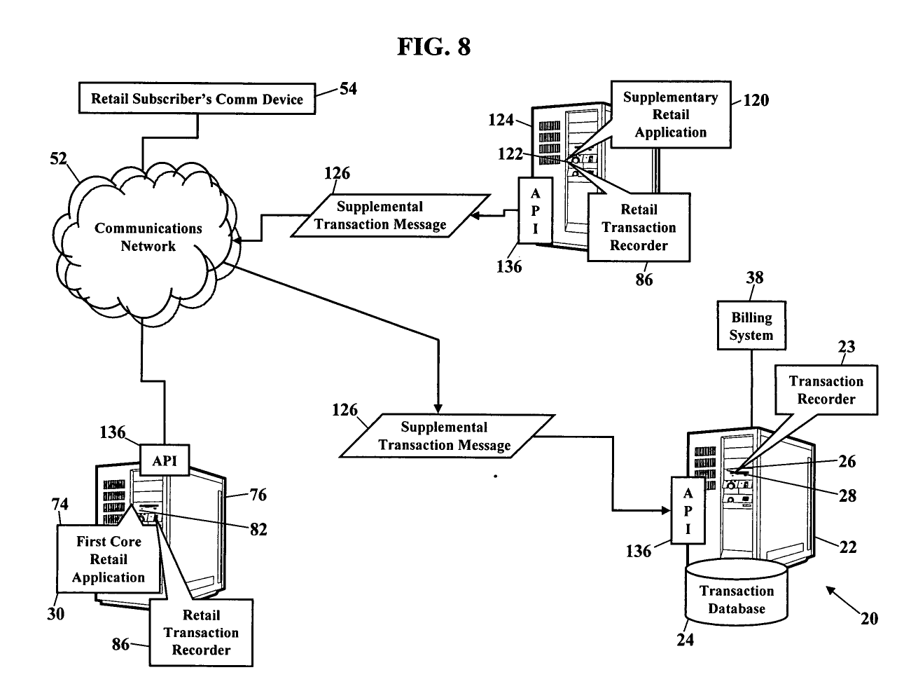

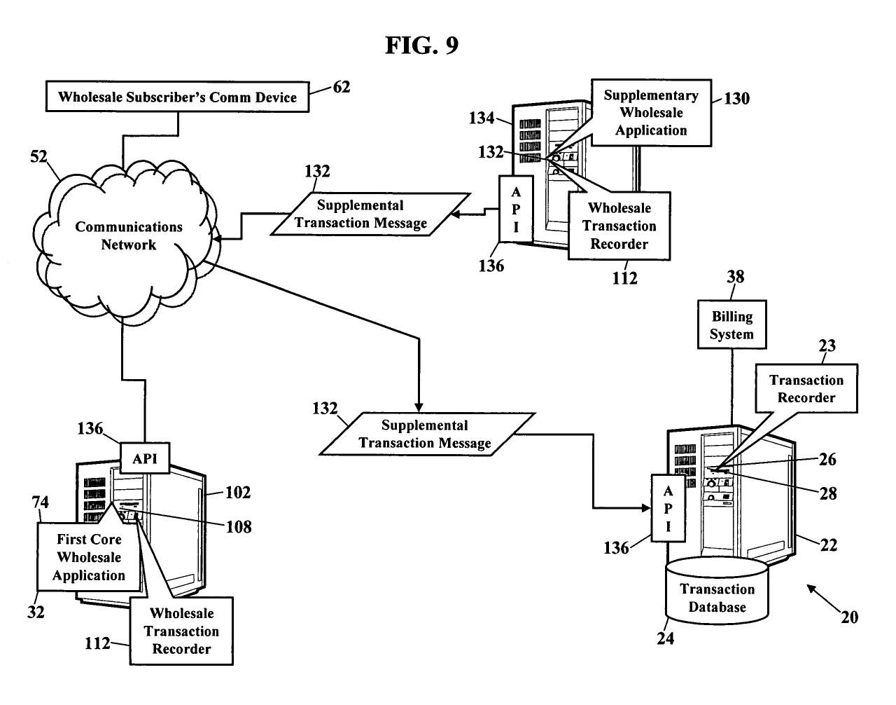

FIGS. 8 and 9 are schematics illustrating supplementary applications, according to exemplary embodiments. FIG. 8 illustrates a supplementary retail application 120 that provides supplemental services to the first core retail application 74. As those of ordinary skill in the art understand, a software application may itself call, query, invoke, or transact with a supplemental software application. The network operator thus wants to capture and document a subscriber's use of any supplemental software applications. Here, then, whenever the first core retail application 74 transacts with the supplementary retail application 120, the network operator wants to record and to bill for that transaction. Here again, then, another instance of the retail transaction recorder 86 stores within memory 122 of a supplemental server 124. The retail transaction recorder 86 observes, records, and/or logs each transaction between the first core retail application 74 and the supplementary retail application 120, on behalf of the retail subscriber's communications device 54. The transaction recorder 86 then sends a supplemental transaction message 126 containing the details of the supplementary transaction. The supplemental transaction message 126 communicates via the communications network 52 to the computer 22, where the processor 28 stores the supplemental transaction message 126 and/or its informational content in the transactions database 24. The billing system 38 may then access the transactions database 24 and account for the subscriber's use of the supplementary retail application 120.

FIG. 9 illustrates a supplementary wholesale application 130. The supplementary wholesale application 130 provides supplemental services to the first core wholesale server 102. Here another instance of the wholesale transaction recorder 112 stores within memory 132 of a supplemental server 134. The wholesale transaction recorder 112 observes, records, and/or logs each transaction between the first core wholesale server 102 and the supplementary wholesale application 130 that occurs on behalf of the wholesale subscriber's communications device 62. The wholesale transaction recorder 112 sends a supplemental transaction message 132 containing the details of the supplementary transaction. The supplemental transaction message 132 communicates via the communications network 52 to the computer 22, where the processor 28 stores the supplemental transaction message 132 and/or its informational content in the system-wide transactions database 24. The billing system 38 may then access the transactions database 24 and account for the subscriber's use of the supplementary wholesale application 130.

An example helps explain supplementary applications. Suppose a supplementary application provides call alerts. This supplementary application may invoke two core applications, such as an address book and a music library. A customer accesses their personalized address book and sets different music alerts (e.g., ring tones) for each entry in the address book. The supplementary application thus provides a distinctive call alert for each incoming call. Exemplary embodiments track the transactions for the supplementary call alert application and how the call alert application uses APIs from the music library and the address book application.

FIGS. 6-9 also illustrate application programming interfaces. Because the network operator may partner with many different software vendors, the various retail and wholesale applications may have compatibility problems. Each of these software vendors may utilize different hardware and software configurations, thus creating a diverse environment that ordinarily presents compatibility problems. FIGS. 6-9, then, illustrate a common set 136 of application programming interfaces. The processor 28 uses the common set 136 of application programming interfaces to access any core application and/or any wholesale application. As those of ordinary skill in the art understand, an application programming interface (API) defines a common or standard software function, command, or request. The common set 136 of application programming interfaces permit any vendor's retail application, or any vendor's wholesale application, to make requests or to exchange data with the transaction recorder 23. The common set 136 of application programming interfaces may include proprietary functions and/or open functions. The common set 136 of application programming interfaces, for example, provide common functions, commands, and/or requests to a Voice over Internet Protocol application, SIP applications and/or protocols, or 3G wireless networks (such as WCDMA and OFDMA). The common set 136 of application programming interfaces may also interact with network-independent APIs, such as those proposed by The Parlay Group and available from www.parlay.org and incorporated herein by reference. Access to the common set 136 of application programming interfaces may be controlled by a multilevel access control system and/or a multilevel pricing scheme. Access to the common set 136 of application programming interfaces may additionally or alternatively be controlled by an interaction logic control to help mitigate potential conflicts between APIs of different systems (such as between an email server and voice server, for example). Access to the common set 136 of application programming interfaces may additionally or alternatively be controlled by subscriber specific controls. Service combinations may include any and all of the following APIs/features in multiple networks, subscriber devices, or separate application servers provided by third parties. Because application programming interfaces are known, this patent will not further describe such interfaces. If the reader desires a more detailed explanation, the reader is invited to consult the following sources, with each source incorporated herein by reference: U.S. Pat. No. 5,652,866 to Aldred et al. (Jul. 29, 1997); U.S. Pat. No. 5,668,988 to Mason et al. (Sep. 16, 1997); U.S. Pat. No. 6,826,758 to Chew et al. (Nov. 30, 2004); U.S. Pat. No. 6,961,944 to Chew et al. (Nov. 1, 2005); Published U.S. Patent Application 2003/0105887 to Cox et al. (Jun. 5, 2003); Published U.S. Patent Application 2003/0126584 to Creamer et al. (Jul. 3, 2003); Published U.S. Patent Application 2004/0007121 to Graves et al. (Jan. 15, 2004); Published U.S. Patent Application 2004/0045015 to Haji-Aghajani et al. (Mar. 4, 2004); and Published U.S. Patent Application 2005/0223392 to Cox et al. (Oct. 6, 2005).

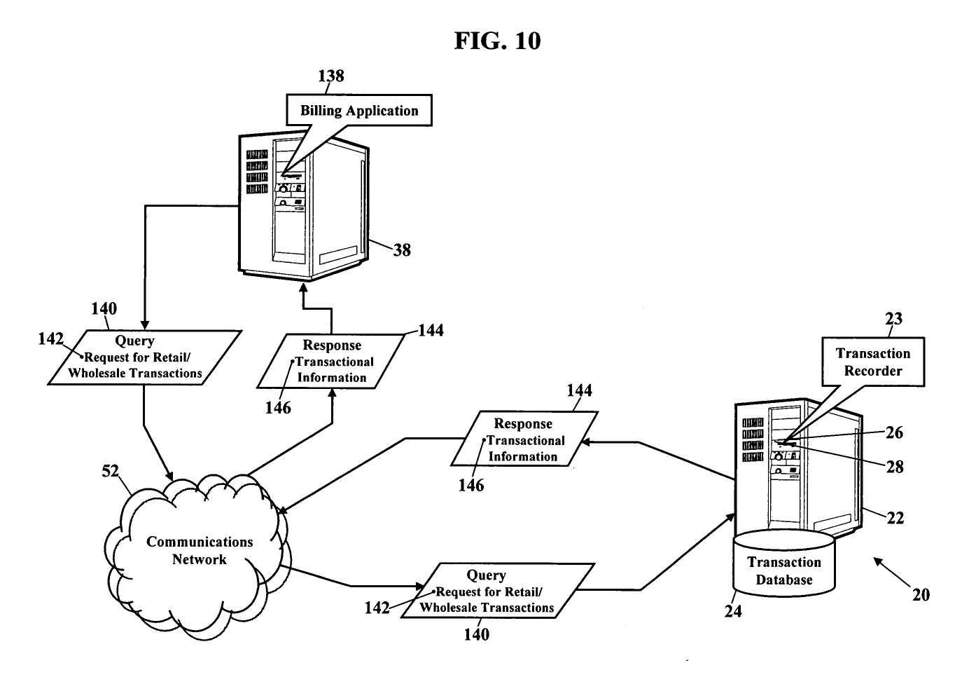

FIG. 10 is a schematic illustrating billing queries, according to more exemplary embodiments. Whenever the billing system 38 needs transaction details, a billing application 138 instructs the billing system 38 to send a query 140. The query 140 may include a request 142 for an individual subscriber's retail transactions and/or wholesale transactions. The query 140 communicates via the communications network 52 to the computer 22. When the processor 28 receives the query 140, the transactions recorder 23 instructs the processor 28 to retrieve the desired transactional information from the transaction database 24. The transactions recorder 23 then instructs the processor 28 to send a response 144. The response 144 communications via the communications network 52 to the billing system 38. The response 144 includes the individual subscriber's transactional information 146, whether retail transactions and/or wholesale transactions. The billing system 38 may thus appropriately bill for the subscriber's use of the retail applications and of the wholesale applications.

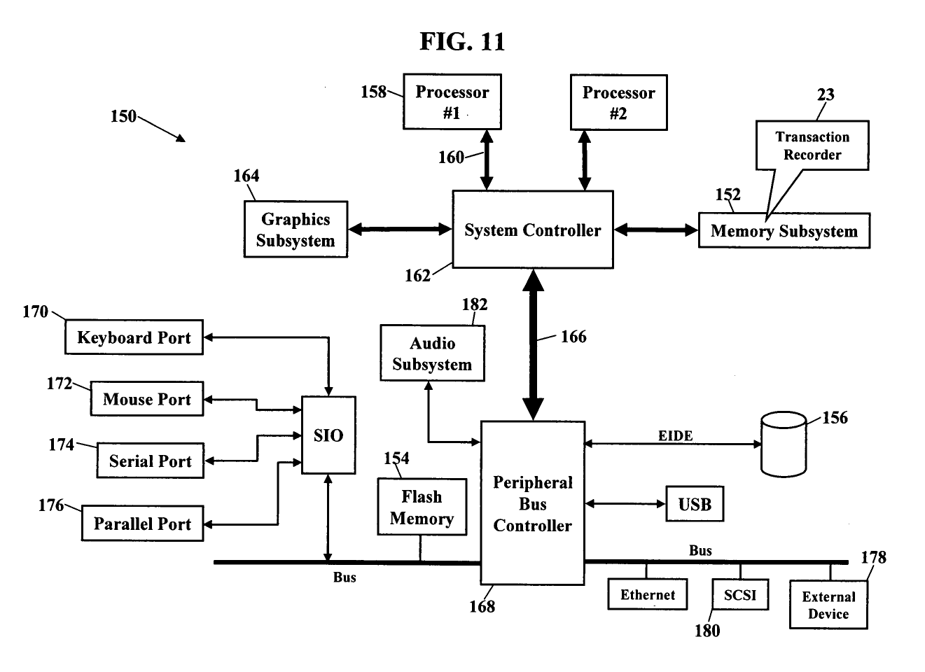

FIG. 11 depicts another possible operating environment for exemplary embodiments. FIG. 11 is a block diagram showing the transaction recorder 23 residing in a processor-controlled system 150 (such as the computer 22, the subscriber's communications device 54 and 62, or any of the servers 76, 80, 102, and 106 variously shown in FIGS. 1-10). FIG. 11, however, may also represent a block diagram of any computer or communications device in which the transaction recorder 23 may operate. The transaction recorder 23 is stored within a system memory device. The transaction recorder 23, for example, is shown residing in a memory subsystem 152. The transaction recorder 23, however, could also reside in flash memory 154 or peripheral storage device 156. The computer system 150 also has one or more central processors 158 executing an operating system. The operating system, as is well known, has a set of instructions that control the internal functions of the computer system 150. A system bus 160 communicates signals, such as data signals, control signals, and address signals, between the central processor 158 and a system controller 162. The system controller 162 provides a bridging function between the one or more central processors 158, a graphics subsystem 164, the memory subsystem 152, and a PCI (Peripheral Controller Interface) bus 166. The PCI bus 166 is controlled by a Peripheral Bus Controller 168. The Peripheral Bus Controller 168 is an integrated circuit that serves as an input/output hub for various peripheral ports. These peripheral ports could include, for example, a keyboard port 170, a mouse port 172, a serial port 174, and/or a parallel port 176 for a video display unit, one or more external device ports 178, and external hard drive ports 180 (such as IDE, ATA, SATA, or SCSI). The Peripheral Bus Controller 168 could also include an audio subsystem 182. Those of ordinary skill in the art understand that the program, processes, methods, and systems described herein are not limited to any particular computer system or computer hardware.

One example of the central processor 158 is a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described herein are not limited to any particular manufacturer's central processor.

According to an exemplary embodiment, any of the WINDOWS® (WINDOWS® is a registered trademark of Microsoft Corporation, One Microsoft Way, Redmond Wash. 98052-6399, 425.882.8080, www.Microsoft.com) operating systems may be used. Other operating systems, however, are also suitable. Such other operating systems would include the UNIX® operating system (UNIX® is a registered trademark of the Open Source Group, www.opensource.org), the UNIX-based Linux operating system, WINDOWS NT®, and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described herein are not limited to any particular operating system.

The system memory device (shown as memory subsystem 152, flash memory 154, or peripheral storage device 156) may also contain another application program. The application program cooperates with the operating system and with a video display unit (via the serial port 174 and/or the parallel port 176) to provide a Graphical User Interface (GUI). The Graphical User Interface typically includes a combination of signals communicated along the keyboard port 170 and the mouse port 172. The Graphical User Interface provides a convenient visual and/or audible interface with a user of the computer system 150.

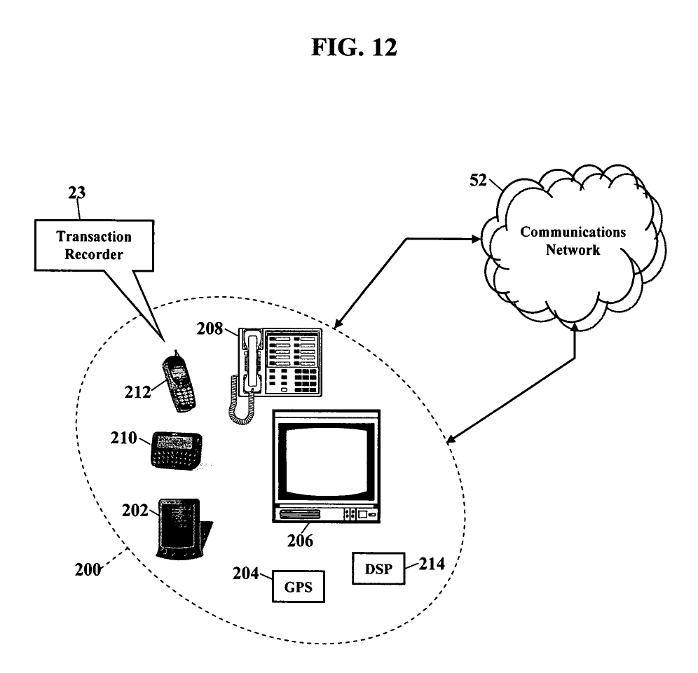

FIG. 12 is a schematic illustrating still more exemplary embodiments. FIG. 12 illustrates that the transaction recorder 23 may alternatively or additionally store within various other communications devices 200. FIG. 12, for example, illustrates that the transaction recorder 23 may entirely or partially store within a personal digital assistant (PDA) 202, a Global Positioning System (GPS) device 204, an interactive television 206, an Internet Protocol (IP) phone 208, a pager 210, a cellular/satellite phone 212, or any computer system and/or communications device utilizing a digital signal processor (DSP) 214. The communications device 200 may also include watches, radios, vehicle electronics, clocks, printers, gateways, and other apparatuses and systems.

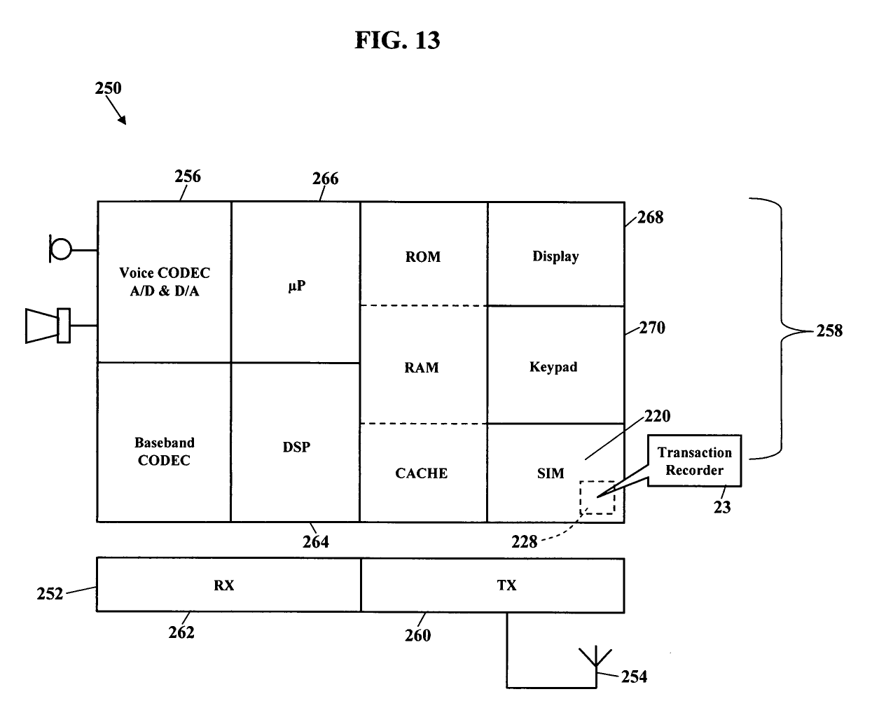

FIG. 13 is a schematic further illustrating various communications devices for provisioning communications services, according to the exemplary embodiments. FIG. 13 is a block diagram of another communications device 250 storing or utilizing any portion of the transaction recorder 23. In one embodiment, the communications device 250 comprises a radio transceiver unit 252, an antenna 254, a digital baseband chipset 256, and a man/machine interface (MMI) 258. The transceiver unit 252 includes transmitter circuitry 260 and receiver circuitry 262 for receiving and transmitting radio-frequency (RF) signals. The transceiver unit 252 couples to the antenna 254 for converting electrical current to and from electromagnetic waves. The digital baseband chipset 256 contains a digital signal processor (DSP) 264 and performs signal processing functions for audio (voice) signals and RF signals. As FIG. 13 shows, the digital baseband chipset 256 may also include an on-board microprocessor 266 that interacts with the man/machine interface (MMI) 258. The man/machine interface (MMI) 258 may comprise a display device 268, a keypad 270, and a Subscriber Identity Module 220. The on-board microprocessor 266 performs GSM protocol functions and control functions for the radio circuitry 260 and 262, for the. display device 268, and for the keypad 270. The on-board microprocessor 266 may also interface with the Subscriber Identity Module 220 and with the transaction recorder 23 residing in the memory module 228 of the Subscriber Identity Module 220. Those skilled in the art will appreciate that there may be many suitable architectural configurations for the elements of the communications device 250. If the reader desires a more detailed explanation, the reader is invited to consult the following sources: LAWRENCE HARTE et al., GSM SUPERPHONES 105-120 (1999); SIEGMUND REDL et al., GSM AND PERSONAL COMMUNICATIONS HANDBOOK 389-474 (1998); and JOACHIM TISAL, GSM CELLULAR RADIO TELEPHONY 99-130 (1997), with each incorporated herein by reference.

The exemplary embodiments may be utilized regardless of signaling standard. As those of ordinary skill in the art recognize, FIG. 13 illustrates a Global System for Mobile (GSM) communications device. That is, the communications device 250 utilizes the Global System for Mobile (GSM) communications signaling standard. Those of ordinary skill in the art also recognize, however, the exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard.

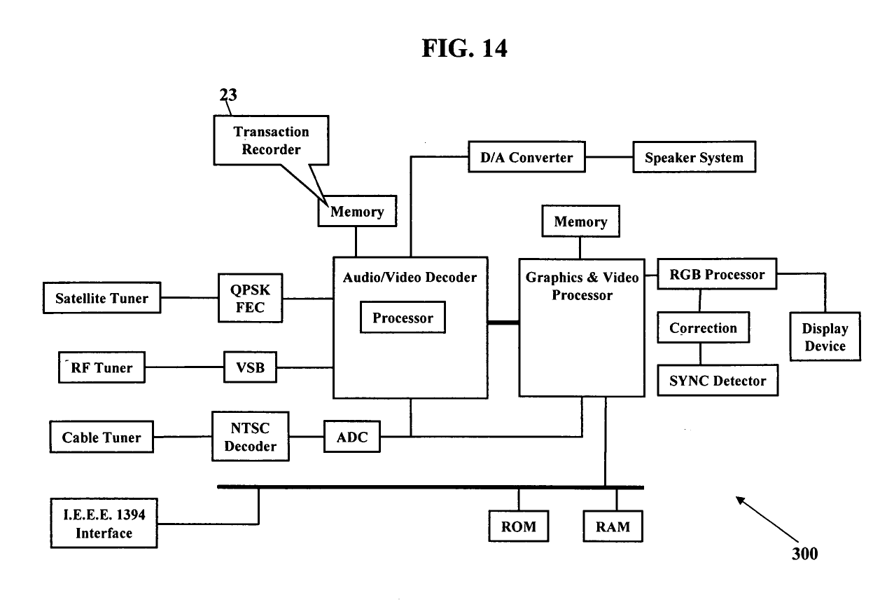

FIG. 14 is a block diagram illustrating another communications device, according to yet more of the exemplary embodiments. Here the communications device is shown as a digital high definition television (HDTV) system 300. Although an HDTV system is shown, the exemplary embodiments are applicable to any television design. The concepts, for example, are applicable to analog circuitry, digital circuitry, analog signals, and/or or digital signals. The television may include an encoder/decoder, such as an embedded set-top box. The term “television,” however, may encompass a stand-alone set-top box that is a separate component from the television. The television may also utilize any display device technology, such as a cathode-ray, a liquid crystal, a diode, digital micromirror, light processor, or plasma. The transaction recorder 23 may be stored in any memory location or device in the television 300. FIG. 14, though, is only a simplified block diagram. The operating and engineering principles are already known in the art and will not be repeated here. If, however, the reader desires more information on the television, the reader is directed to the following sources: MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004), with each incorporated herein by reference.

The transaction recorder 23 may be physically embodied on or in a computer-readable medium. This computer-readable medium may include CD-ROM, DVD, tape, cassette, floppy disk, memory card, and large-capacity disk (such as IOMEGAO®, ZIP®, JAZZ®, and other large-capacity memory products (IOMEGAO®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments, allow easy dissemination. A computer program product comprises the computer-readable medium storing processor-executable or computer-readable instructions, as the exemplary embodiments describe.

The exemplary embodiments may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for monitoring transactions, comprising:
receiving retail transaction messages describing retail transactions between retail subscribers and a software application;
receiving wholesale transaction messages describing wholesale transactions between the software application and wholesale subscribers of a reseller of communications services;
storing the retail transaction messages in a transactions database; and
storing the wholesale transaction messages in the transactions database.

2. A method according to claim 1, wherein the retail transaction messages describe transactions with retail applications offered by a network provider.

3. A method according to claim 1, wherein the wholesale transaction messages describe transactions with wholesale applications offered by the reseller of communications services.

4. A method according to claim 1, further comprising the step of receiving a query from a billing application for an individual subscriber's retail transactions.

5. A method according to claim 1, further comprising the step of receiving a query from a billing application for an individual subscriber's wholesale transactions.

6. A method according to claim 1, further comprising the step of accounting for an individual subscriber's usage of retail applications offered by a network provider and wholesale applications offered by the reseller of communications services.

7. A method according to claim 1, further comprising the step of using a common set of application programming interfaces to access a core application.

8. A system, comprising:
a transactions database stored in memory; and
a processor communicating with the memory,
wherein the processor receives retail transaction messages describing retail transactions between retail subscribers and a software application,
the processor receives wholesale transaction messages describing wholesale transactions between the software application and wholesale subscribers of a reseller of communications services,
the processor stores the retail transaction messages in the transactions database, and
the processor stores the wholesale transaction messages in the transactions database.

9. A system according to claim 8, wherein the retail transaction messages describe transactions with retail applications offered by a network provider.

10. A system according to claim 8, wherein the wholesale transaction messages describe transactions with wholesale applications offered by the reseller of communications services.

11. A system according to claim 8, wherein the processor receives a query from a billing application for an individual subscriber's retail transactions.

12. A system according to claim 8, wherein the processor receives a query from a billing application for an individual subscriber's wholesale transactions.

13. A system according to claim 8, wherein the processor accounts for an individual subscriber's usage of retail applications offered by a network provider and wholesale applications offered by the reseller of communications services.

14. A system according to claim 8, wherein the processor uses a common set of application programming interfaces to access a core application.

15. A computer program product comprising a computer-readable medium storing computer-readable instructions for performing the steps:
receiving retail transaction messages describing retail transactions between retail subscribers and a software application;
receiving wholesale transaction messages describing wholesale transactions between the software application and wholesale subscribers of a reseller of communications services;
storing the retail transaction messages in a transactions database; and
storing the wholesale transaction messages in the transactions database.

16. A computer program product according to claim 15, further comprising computer code for receiving the retail transaction messages describing transactions with retail applications offered by a network provider.

17. A computer program product according to claim 15, further comprising computer code for receiving the wholesale transaction messages describing transactions with wholesale applications offered by the reseller of communications services.

18. A computer program product according to claim 15, further comprising computer code for receiving a query from a billing application for an individual subscriber's retail transactions.

19. A computer program product according to claim 15, further comprising computer code for receiving a query from a billing application for an individual subscriber's wholesale transactions.

20. A computer program product according to claim 15, further comprising computer code for accounting for an individual subscriber's usage of retail applications offered by a network provider and for wholesale applications offered by the reseller of communications services.
